(19) United States
(12) Patent Application Publication
(10) Pub. No.: US 2011/0031759 A1
(43) Pub. Date: Feb. 10, 2011

(54) Foam filling material for wind power generator blades, foam filling member for wind power generator blades, wind power generator blade, wind power generator, and method for producing the wind power generator blade

(75) Inventors: Yoshiaki Mitsuoka, Osaka (JP); Takehiro Ui, Osaka (JP); Takuji Okeyui, Osaka (JP)

Correspondence Address: AKERMAN SENTERFITT, 8100 BOONE BOULEVARD, SUITE 700, VIENNA, VA, 22182-2683, US

(73) Assignee: Nitto Denko Corporation, Osaka (JP)

(21) Appl. No.: 12/805,320

(22) Filed: Jul. 26, 2010

Related U.S. Application Data
(60) Provisional application No. 61/272,003, filed on Aug. 6, 2009.

(30) Foreign Application Priority Data
Aug. 5, 2009 (JP) 2009-182403

(51) Int. Cl. F03D 9/00; F03B 3/12; B21K 3/04

(52) U.S. Cl. 290/55; 416/241 R; 29/889.7

(57) ABSTRACT

A foam filling material for wind power generator blades is obtained by forming a foam filling composition containing a polymer and a foaming agent into a given shape so as to be positioned in an interior space of a wind power generator blade, and is capable of filling the interior space of the wind power generator blade by foaming.

The present application claims the benefit of U.S. Provisional Application No. 61/272,003 filed on Aug. 6, 2009, and claims priority from Japanese Patent Application No. 2009-182403 filed on Aug. 5, 2009, the contents of which are herein incorporated by reference into this application.

### BACKGROUND OF THE INVENTION

1. Field of the Invention

The present invention relates to a foam filling material for wind power generator blades, a foam filling member for wind power generator blades including the foam filling material, a wind power generator blade using the foam filling material and the foam filling member, a wind power generator including the blade, and a method for producing the wind power generator blade.

2. Description of Related Art

In recent years, wind power generators have been received much attention from the viewpoint of CO₂ reduction associated with global warming prevention. The wind power generator usually includes a support and a blade (vane) rotatably supported on the support, the blade rotating in response to wind forces, so that the rotational force thereof can generate electric power.

In the wind power generator, the rigidity capable of bearing wind forces is required for the blade. However, the higher the rigidity is, the more the weight of the blade increases. Then, vibration noise increases along with the increased weight, or power generation efficiency deteriorates. Therefore, the blade is required to have high rigidity and light weight.

From the above viewpoints, there has been proposed, for example, a windmill blade which is composed of a skin material consisting of carbon fiber reinforced plastic, and a core material consisting of a low density foamed material enclosed by the skin material (cf. Japanese Unexamined Patent Publication No. 2006-274990).

### SUMMARY OF THE INVENTION

In the windmill blade described in Japanese Unexamined Patent Publication No. 2006-274990, however, when a gap occurs between the inner surface of the skin material and the outer surface of the core material, vibration cannot be suppressed effectively, further failing to secure the rigidity of the skin material.

It is an object of the present invention to provide a wind power generator blade which secures rigidity and is excellent in lightweight and vibration damping property, a wind power generator, and a method for producing the wind power generator blade, a foam filling material for wind power generator blades used therefor, and a foam filling member for wind power generator blades.

The foam filling material for wind power generator blades of the present invention is obtained by forming a foam filling composition including a polymer and a foaming agent into a given shape so as to be positioned in an interior space of a wind power generator blade, and is capable of filling the interior space of the wind power generator blade by foaming.

When the foam filling material for wind power generator blades of the present invention is positioned in the interior space of the wind power generator blade and foamed, the interior space of the wind power generator blade is filled with the foamed material obtained by foaming. This can prevent a gap from occurring between the inner side surface of the wind power generator blade and the outer side surface of the foamed material. As a result, vibration can be effectively suppressed and further, the rigidity of the wind power generator blade can be secured.

The foam filling member for wind power generator blades of the present invention includes the above-mentioned foam filling material for wind power generator blades and an attachment member mounted to the foam filling material for wind power generator blades and attachable in the interior space of the wind power generator blade.

According to the foam filling member for wind power generator blades of the present invention, the foam filling material for wind power generator blades can be attached in the interior space of the wind power generator blade using the attachment member. This allows the foam filling material for wind power generator blades to be placed in the interior space of the wind power generator blade by reliably positioning the foam filling material corresponding to the size and shape of the wind power generator blade. As a result, vibration can be more effectively suppressed and furthermore, the rigidity of the wind power generator blade can be secured.

In the foam filling member for wind power generator blades of the present invention, it is preferable that the attachment member comprises a supporting portion for supporting the foam filling material for wind power generator blades.

When the foam filling material for wind power generator blades is supported by the supporting portion, the foam filling material for wind power generator blades can be arranged in a more suitable position in the interior space of the wind power generator blade.

In the foam filling member for wind power generator blades of the present invention, it is preferable that the supporting portion supports the foam filling material for wind power generator blades so as to regulate a foaming direction of the foam filling material for wind power generator blades.

When the supporting portion is used to regulate the foaming direction of the foam filling material for wind power generator blades, a space required to be filled in the interior space of the wind power generator blade can be more reliably filled.

In the foam filling member for wind power generator blades of the present invention, it is preferable that the supporting portion supports the foam filling material for wind power generator blades so that the foam filling material for wind power generator blades is positioned between an inner side surface of the wind power generator blade and the supporting portion.

When the foam filling material for wind power generator blades is positioned between the inner side surface of the wind power generator blade and the supporting portion, the foamed material obtained by foaming is reliably filled between the inner side surface of the wind power generator blade and the outer side surface of the foamed material. This can prevent a gap from occurring between the inner side surface of the wind power generator blade and the outer side surface of the foamed material.

The foam filling member for wind power generator blades of the present invention includes the above-mentioned foam filling material for wind power generator blades and a reinforcing member covered with the foam filling material for wind power generator blades to reinforce the interior space of the wind power generator blade.

According to the foam filling member for wind power generator blades of the present invention, the reinforcing member can reinforce the wind power generator blade. As a result, while the reinforcing member can further increase the rigidity of the wind power generator blade, the foam filling material for wind power generator blades can effectively suppress vibration.

In the foam filling member for wind power generator blades of the present invention, it is preferable that the reinforcing member includes a plurality of partition walls for dividing the interior space of the wind power generator blade into a plurality of spaces.

Since the reinforcing member includes the plurality of partition walls, the wind power generator blade can be reduced in weight, and the rigidity thereof can be improved.

The wind power generator blade of the present invention has its interior space filled with a foamed material obtained by positioning the above-mentioned foam filling material for wind power generator blades or foam filling member for wind power generator blades in the interior space of the wind power generator blade and then foaming it.

Therefore, a gap can be prevented from occurring between the inner side surface of the wind power generator blade and the outer side surface of the foamed material, resulting in effective suppression of vibration, and furthermore, the rigidity of the wind power generator blade can be secured.

The wind power generator of the present invention includes the above-mentioned wind power generator blade.

According to the wind power generator, vibration can be effectively suppressed and furthermore, the rigidity of the wind power generator blade can be secured, so that vibration noise can be reduced, and durability and power generation efficiency can be improved.

The method for producing the wind power generator blade of the present invention includes the steps of forming a foam filling composition containing a polymer and a foaming agent into a given shape so as to be positioned in an interior space of the wind power generator blade to thereby obtain a foam filling material for wind power generator blades; positioning the foam filling material for wind power generator blades in the interior space of the wind power generator blade; and foaming the foam filling material for wind power generator blades to fill the interior space of the wind power generator blade.

In this method, the foam filling material for wind power generator blades is positioned in the interior space of the wind power generator blade and then foamed to fill the interior space thereof. This can prevent a gap from occurring between the inner side surface of the wind power generator blade and the outer side surface of the foamed material. As a result, vibration can be effectively suppressed and furthermore, the rigidity of the wind power generator blade can be secured.

### BRIEF DESCRIPTION OF THE DRAWINGS

FIG. 1 is a front view showing one embodiment of a wind power generator of the present invention;

FIG. 2(a) is a sectional view taken along the line A-A in FIG. 1, showing one embodiment of a wind power generator blade (before foaming) of the present invention;

FIG. 2(b) is a schematic plan view of a major portion of one embodiment of a foam filling member for wind power generator blades according to the present invention;

FIG. 3 is a sectional view taken along the line A-A in FIG. 1, showing the wind power generator blade (after foaming) shown in FIG. 2(a);

FIG. 4(a) is a schematic sectional view of a major portion of a wind power generator blade (before foaming) which adopts another embodiment (a mode where the foaming direction of a foam filling material for wind power generator blades is regulated by a supporting portion) of the foam filling member for wind power generator blades according to the present invention;

FIG. 4(b) is a schematic sectional view of a major portion of a wind power generator blade (after foaming) which adopts the foam filling member for wind power generator blades shown in FIG. 4(a);

FIG. 5(a) is a schematic plan view of another embodiment (a mode where a foam filling material for wind power generator blades is arranged between the inner side surface of the wind power generator blade and a supporting portion) of the foam filling member for wind power generator blades according to the present invention;

FIG. 5(b) is a sectional view of a wind power generator blade (before foaming) which adopts the foam filling member for wind power generator blades shown in FIG. 5(a);

FIG. 5(c) is a sectional view of a wind power generator blade (after foaming) which adopts the foam filling member for wind power generator blades shown in FIG. 5(b);

FIG. 6(a) is a sectional view of a wind power generator blade (before foaming) which adopts another embodiment (a mode where a reinforcing member made of foamed material is covered with a foam filling material for wind power generator blades) of the foam filling member for wind power generator blades of the present invention;

FIG. 6(b) is a sectional view of a wind power generator blade (after foaming) which adopts the foam filling member for wind power generator blades shown in FIG. 6(a);

FIG. 7(a) is a sectional view of a wind power generator blade (before foaming) which adopts another embodiment (a mode where a reinforcing member made of a honeycomb structured body is covered with a foam filling material for wind power generator blades) of the foam filling member for wind power generator blades of the present invention;

FIG. 7(b) is a sectional view of a wind power generator blade (after foaming) which adopts the foam filling member for wind power generator blades shown in FIG. 7(a);

FIG. 8(a) is a schematic sectional view of a major portion of a wind power generator blade (before foaming) which adopts another embodiment (a mode where a loop shape of a foam filling material for wind power generator blades is held by an attachment member) of the foam filling member for wind power generator blades of the present invention;

FIG. 8(b) is a schematic sectional view of a major portion of a wind power generator blade (after foaming) which adopts the foam filling member for wind power generator blades shown in FIG. 8(a);

FIG. 9(a) is a schematic sectional view of a major portion of a wind power generator blade (before foaming) which adopts another embodiment (a mode where a foam filling material for wind power generator blades having a loop shape is fixed by engaging slits in the overlapping portion) of the foam filling member for wind power generator blades of the present invention;

FIG. 9(b) is a schematic sectional view of a major portion of a wind power generator blade (after foaming) which adopts the foam filling member for wind power generator blades shown in FIG. 9(a);

FIG. 10(a) is a sectional view of a wind power generator blade (before foaming) which adopts another embodiment (a mode where a foam filling material for wind power generator blades is fixed with an adhesive layer) of the foam filling member for wind power generator blades of the present invention; and

FIG. 10(b) is a sectional view of a wind power generator blade (after foaming) which adopts the foam filling member for wind power generator blades shown in FIG. 10(a).

### DETAILED DESCRIPTION OF PREFERRED EMBODIMENTS

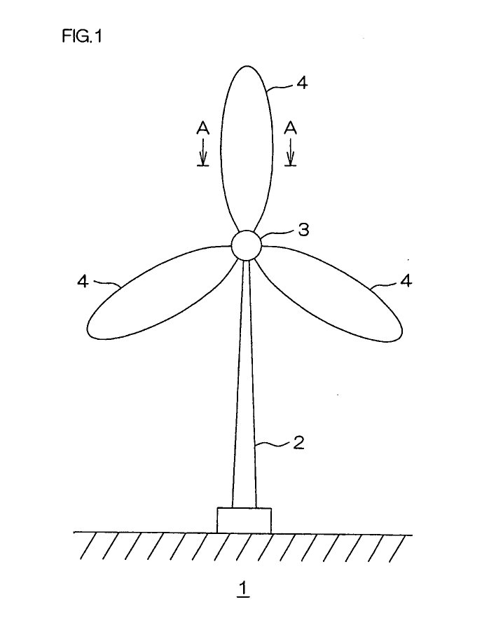

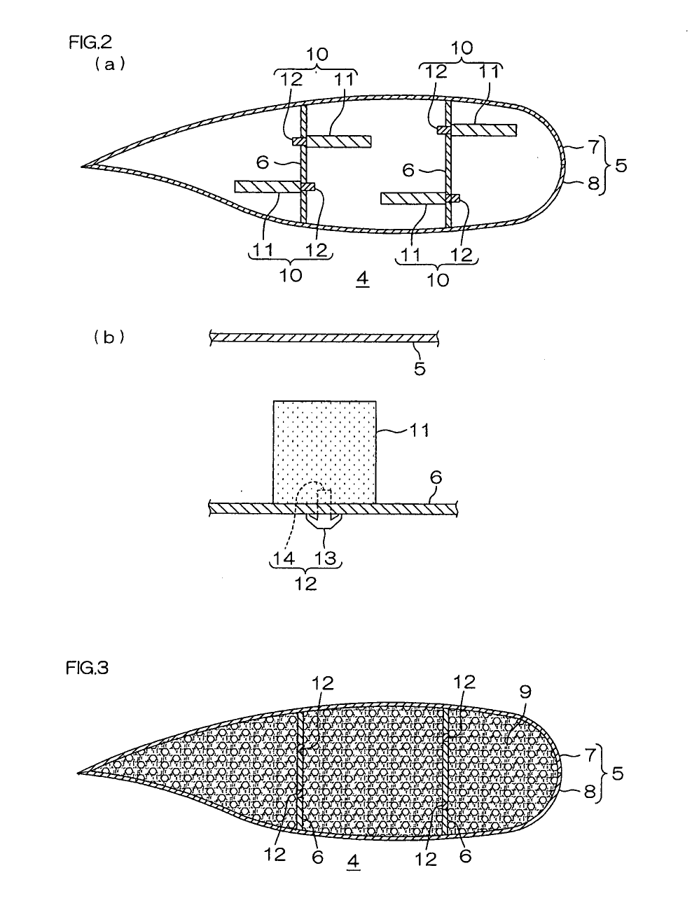

FIG. 1 is a front view showing one embodiment of a wind power generator of the present invention; FIG. 2(a) is a sectional view taken along the line A-A in FIG. 1, showing one embodiment of a wind power generator blade (before foaming) of the present invention; FIG. 2(b) is a schematic plan view of a major portion of one embodiment of a foam filling member for wind power generator blades according to the present invention; and FIG. 3 is a sectional view taken along the line A-A in FIG. 1, showing the wind power generator blade (after foaming) shown in FIG. 2(a).

In FIG. 1, the wind power generator 1 includes a support 2 vertically arranged in a standing condition, a rotating shaft 3 provided on the upper end portion of the support 2, and a wind power generator blade 4 connected to the rotating shaft 3 and rotatably provided on the support 2.

The wind power generator blade 4 composes a plurality of vanes radially extended from the rotating shaft 3, and has a skin 5 and a girder 6 as shown in FIG. 2(a).

The skin 5 has a generally drop-shaped cross-section and is formed from a half-split structure including a first skin 7 and a second skin 8. The skin 5 is also formed in a hollow structure in the following manner: After the girder 6 and a foam filling member 10 for wind power generator blades are disposed, both ends of the first skin 7 and the second skin 8 are abutted against each other in opposed relation, and these abutted skins are connected to form a hollow space (closed cross section).

The materials that may be used to form the skin 5 include, for example, carbon such as a carbon fiber; synthetic resin such as FRP (fiber reinforced plastics), polypropylene, polyvinyl chloride (PVC), polyester, and epoxy; metal such as aluminium alloy, magnesium alloy, titanium alloy, and ferrous steel; and wood such as balsa. Of these, FRP is preferable.

The girder 6 is arranged in the hollow space of the skin 5, coupled to the inner side surface of the first skin 7 and the inner side surface of the second skin 8, and is formed in the shape of a generally flat plate extending along the radial direction of the wind power generator blade 4. A plurality (two) of the girders 6 are arranged in spaced relation from each other in the rotation direction of the wind power generator blade 4, each arranged over the radial direction of the wind power generator blade 4.

The materials that may be used to form the girder 6 are the same materials as used to form the skin 5 mentioned above.

The foam filling member 10 for wind power generator blades is used to form a foamed material 9 (see FIG. 3) filled in the interior space of the wind power generator blade 4, and as shown in FIG. 2(b), it includes a foam filling material 11 for wind power generator blades and a clip 12 attached to the foam filling material 11 for wind power generator blades as an attachment member capable of attaching in the interior space of the wind power generator blade 4.

Although details will be described later, the foam filling material 11 for wind power generator blades is formed, for example, in a generally rectangular sheet shape in plan view, using a foam filling composition (to be described later) which is foamed by heating.

No particular limitation is imposed on the clip 12. The clip 12 is composed of, for example, a hard resin and is formed by injection molding or the like.

Such clip 12 integrally includes a fixing hook 13 for fixing the foam filling material 11 for wind power generator blades in the interior space of the wind power generator blade 4 and a lock 14 which locks the foam filling material 11 for wind power generator blades.

The foam filling member 10 for wind power generator blades is formed by inserting the clip 12 in the foam filling material 11 for wind power generator blades so that the lock 14 is embedded under the peripheral end of the foam filling material 11 for wind power generator blades.

This foam filling member 10 for wind power generator blades is fixed to the girder 6 by inserting through the girder 6 so that the fixing hook 13 of the clip 12 penetrate the girder 6 in the thickness direction.

Therefore, as shown in FIG. 2(a), the foam filling member 10 for wind power generator blades (including the foam filling material 11 for wind power generator blades) is positioned by fixing in the interior space of the wind power generator blade 4.

Although details will be described later, the wind power generator blade 4 (before foaming) is heated under appropriate conditions to foam, crosslink, and cure the foam filling material 11 for wind power generator blades, thereby forming the foamed material 9 to fill up in the interior space of the wind power generator blade 4.

Thus, as shown in FIG. 3, the wind power generator blade 4 (after foaming) with its interior space being filled up with the foamed material 9 can be obtained.

One embodiment of the method for producing a wind power generator blade of the present invention will be described in detail below.

In this method, first, a foam filling composition containing a polymer and a foaming agent is formed into a given shape so as to be positioned in the interior space of a wind power generator blade, thereby obtaining a foam filling material 11 for wind power generator blades.

The polymer is not particularly limited, and examples thereof include resin, rubber, and thermoplastic elastomer.

The resin is not particularly limited, and examples thereof include ethylene-vinyl acetate copolymer (EVA), ethylene ethyl acrylate copolymer (EEA), ethylene butyl acrylate copolymer (EBA), olefine resin (e.g., polyethylene, polypropylene, etc.), polyester, polyvinyl butyral, polyvinyl chloride, polyamide, and polyketone. Of these, ethylene-vinyl acetate copolymer is preferable. The use of ethylene-vinyl acetate copolymer allows increasing of the foaming ratio.

The rubber is not particularly limited, and examples thereof include aromatic rubbers such as styrene-butadiene rubber (SBR); and non-aromatic rubbers such as butadiene rubber (1,4-polybutadiene rubber) (BR), syndyotactic-1,2-polybutadiene rubber, acrylonitrile-butadiene rubber, polychloroprene rubber, nitrile rubber, butyl rubber, isoprene rubber, and natural rubber. The rubber also includes, for example, ethylenepropylenediene rubber (EPDM). Of these, aromatic rubber is preferable, or styrene-butadiene rubber is more preferable.

The thermoplastic elastomer is not particularly limited, and examples thereof include styrene thermoplastic elastomer, olefin thermoplastic elastomer, urethane thermoplastic elastomer, polyester thermoplastic elastomer, polyamide thermoplastic elastomer, 1,2-polybutadiene thermoplastic elastomer, and vinyl chloride thermoplastic elastomer. Of these, styrene thermoplastic elastomer is preferable.

More specifically, examples of the styrene thermoplastic elastomer include styrene butadiene styrene block copolymer (SBS), styrene isoprene styrene block copolymer, and styrene ethylenebutylene styrene block copolymer.

These polymers can be used alone or in combination of two or more kinds.

The foaming agent is not particularly limited and includes, for example an inorganic foaming agent and an organic foaming agent.

Examples of the inorganic foaming agent include ammonium carbonate, ammonium hydrogen carbonate, sodium hydrogen carbonate, ammonium nitrite, sodium borohydride and azides.

Examples of the organic foaming agent include an N-nitroso compound (N,N′-dinitrosopentamethylenetetramine, N,N′-dimethyl-N,N′-dinitrosoterephthalamide, etc.), an azoic compound (e.g., azobis(isobutyronitrile), azodicarboxylic amide, barium azodicarboxylate, etc.), alkane fluoride (e.g., trichloromonofluoromethane, dichloromonofluoromethane, etc.), a sulfonyl hydrazide compound (e.g., p-toluene sulfonylhydrazide, diphenylsulfone-3,3′-disulfonylhydrazide, 4,4′-oxybis(benzenesulphonylhydrazide, allylbis(sulfonylhydrazide), 2,4-toluene disulfonylhydrazide, p,p-bis(benzenesulfonylhydrazide) ether, benzene-1,3-disulfonylhydrazide, benzenesulfonyl hydrazide, etc.), a sulfonyl semicarbazide compound (e.g., p-toluoylenesulfonyl semicarbazide, 4,4′-oxybis(benzene sulfonyl semicarbazide, etc.), and a triazole compound (e.g., 5-morphoryl-1,2,3,4-thiatriazole, etc.).

The foaming agents may be in the form of thermally expansible microparticles (thermally expansible microballoon) comprising microcapsules formed by encapsulating a thermally expansive compound (e.g., isobutane, pentane, etc.) in a microcapsule (e.g., microcapsule of thermoplastic resin such as vinylidene chloride, acrylonitrile, acrylic ester, and methacrylic ester). Commercially available products such as Microsphere (product name; manufactured by Matsumoto Yushi-Seiyaku Co., Ltd.), maybe used as the thermally expansible microparticles.

These foaming agents can be used alone or in combination of two or more kinds.

Of these foaming agents, an azo compound and a sulfonylhydrazide compound are preferable. When an azo compound or a sulfonylhydrazide compound is used, since a foaming gas is a nitrogen gas, high foaming can be realized because of low permeability to the polymer.

The amount of the foaming agent is in the range of, for example, 5 to 40 parts by weight, or preferably 10 to 30 parts by weight, per 100 parts by weight of the polymer. The amount of the foaming agent is also, for example, 5 parts by weight or more, preferably 5 to 20 parts by weight, or more preferably 7 to 15 parts by weight, per 100 parts by weight of the foam filling composition.

When the amount of the foaming agent is 5 parts by weight or more per 100 parts by weight of the foam filling composition, the foaming ratio of 10 times or more can be easily achieved. Conversely, when the amount of the foaming agent exceeds the above range, the foaming ratio corresponding to this amount cannot be obtained, which may cause disadvantage in cost.

If desired, a foaming auxiliary agent can be used in combination with the foaming agent.

Example of the foaming auxiliary agent include an amine compound (except a urea compound), a zinc compound, a urea compound, a benzoic compound, and higher fatty acid such as salicylic acid and stearic acid, or metal salts thereof (except a zinc compound).

The amine compound is an organic compound containing a primary amino group (−NH₂) or a secondary amino group (>NH). For example, when 4,4′-oxybis(benzenesulphonylhydrazide) is blended as a foaming agent, the amine compound is blended in order to reduce the decomposition temperature of the foaming agent.

Examples of the organic compound containing a primary amino group include dicyandiamides, and more specifically, a dicyandiamide.

Examples of the organic compound containing a secondary amino group include dicyclohexylamine salts.

Dicyclohexylamine salts are formed of, for example, dicyclohexylamine (base component) and an acid component. Examples of the acid component include alcohol such as, for example, monohydric alcohol such as ethanol, or polyhydric alcohol such as ethylene glycol; inorganic acid such as, for example, hydrochloric acid, nitric acid, hydrobromic acid (HBr), hydroiodic acid (HI), or sulfuric acid; and organic acid such as, for example, acetic acid. Of these acid components, preferably alcohol, more preferably polyhydric alcohol, or even more preferably ethylene glycol is used.

Of these amine compounds, dicyandiamide, or the dicyclohexylamine salt of ethylene glycol is preferably used.

A generally commercially available amine compound can be used, and for example, DICYANEX 325 (dicyandiamide, available from Air Products & Chemicals, Inc.) or NOCMASTER EGS (a mixture of a dicyclohexylamine salt of ethylene glycol (80%) and a long-chain alkyl alcohol (20%), available from OUCHI SHINKO CHEMICAL INDUSTRIAL CO., LTD.) is used.

These amine compounds can be used alone or in combination of two or more kinds.

The amount of the amine compound is in the range of 5 parts by weight or more, or preferably 10 parts by weight or more, and for example, 200 parts by weight or less, preferably 180 parts by weight or less, or more preferably 130 parts by weight or less, per 100 parts by weight of 4,4′-oxybis(benzenesulphonylhydrazide).

When the amount of the amine compound is less than 5 parts by weight, the decomposition temperature of 4,4′-oxybis(benzenesulphonylhydrazide) cannot be reduced, which may fail to obtain a high foaming ratio.

Conversely, when the amount of the amine compound is more than 200 parts by weight, an excess of the amine compound is mixed. Therefore, the decomposition temperature of 4,4′-oxybis(benzenesulphonylhydrazide) cannot be reduced to a given temperature or less, which may cause disadvantage in cost.

Examples of the zinc compound include zinc oxide and fatty acid zinc. Of these, zinc oxide is preferable mentioned from the viewpoint of low hygroscopicity. Fatty acid zinc is also preferable from the viewpoint of the foaming temperature to be described later.

The fatty acid zinc is a salt of a fatty acid anion (RCOO⁻: R shows a long chain alkyl group or a long chain alkenyl group.) and a zinc cation (Zn²⁺).

The fatty acid anion has, for example, 12 to 18 carbon atoms, and specific examples of the fatty acid anion include anion of a saturated fatty acid such as lauric acid (C₁₁H₂₃COOH), myristic acid (C₁₃H₂₇COOH), and stearic acid (C₁₇H₃₅COOH); and anion of a unsaturated fatty acid such as oleic acid (C₁₇H₃₃COOH).

Specific examples of the fatty acid zinc include saturated fatty acid zinc formed of a saturated fatty acid anion and a zinc cation such as zinc laurate (Zn(C₁₁H₂₃COO)₂) (24 total carbon atoms), zinc myristate (Zn(C₁₃H₂₇COO)₂) (28 total carbon atoms), and zinc stearate (Zn(C₁₇H₃₅COO)₂) (36 total carbon atoms); and unsaturated fatty acid zinc formed of an unsaturated fatty acid anion and a zinc cation such as zinc oleate (Zn(C₁₇H₃₃COO)₂) (36 total carbon atoms). Of these, a saturated fatty acid zinc is preferable.

The blending of such zinc compound with a foam filling composition can provide excellent storage stability in the foam filling composition, and for example, when azodicarboneamide is blended as a foaming agent, the foaming temperature of the foaming agent can be reduced. In particular, when the zinc compound is fatty acid zinc, the foam filling composition can be sufficiently foamed even at relatively low temperature.

The amount of the zinc compound is in the range of, for example, 1 to 20 parts by weight, or preferably 2 to 10 parts by weight, per 100 parts by weight of the polymer.

These foaming auxiliary agents can be used alone or in combination of two or more kinds.

The amount of the foaming auxiliary agent excluding an amine compound and a zinc compound is appropriately selected according to the purposes and applications.

If desired, a crosslinking agent can also be blended with the foam filling composition.

The crosslinking agent is not particularly limited, and examples thereof include sulfur (powder sulfur and insoluble sulfur), sulfur compounds, selenium, magnesium oxide, lead monoxide, organic peroxides (e.g., dicumyl peroxide (DCP), 1,1-ditertiarybutylperoxy-3,3,5-trimethylcyclohexane, 2,5-dimethyl-2,5-ditertiarybutylperoxyhexane, 2,5-dimethyl-2,5-ditertiarybutylperoxyhexyne, 1,3-bis(tertiarybutylperoxyisopropyl)benzene, tertiarybutylperoxyketone, tertiarybutylperoxy benzoate), polyamines, oximes (e.g., p-quinonedioxime, p,p′-dibenzoylquinonedioxime, etc.), nitroso compounds (e.g., p-dinitroso benzine etc.), resins (e.g., alkyl phenol-formaldehyde resin, melamine-formaldehyde condensate, etc.), and ammonium salts (e.g., ammonium benzoate, etc.). Preferably, DCP is used.

These crosslinking agents can be used alone or in combination of two or more kinds.

The amount of the crosslinking agent is not particularly limited, and is in the range of, for example, 0.1 to 10 parts by weight, or preferably 1 to 7 parts by weight, per 100 parts by weight of the polymer. When the amount of the crosslinking agent is less than this range, the viscosity is poorly increased by crosslinking, and thus gas pressure during foaming may break foams. Conversely, when the amount of the crosslinking agent is more than this range, excessive crosslinking occurs, so that the polymer coating may suppress the gas pressure during foaming to cause poor foaming with a high foaming ratio.

If desired, a basic oxide can also be blended with the foam filling composition.

The basic oxide is not particularly limited as long as it is an oxide which can neutralize the acid generated by decomposition of the foaming agent. Examples of the basic oxide include calcium oxide (CaO), magnesium oxide (MgO), ferrous oxide (FeO), and ferric oxide (Fe₂O₃).

These basic oxides can be used alone or in combination of two or more kinds.

When the foam filling composition contains a basic oxide, even if the heating during foaming decomposes the foaming agent to generate acid, the basic oxide can neutralize the acid. This can prevent the wind power generator blades 4 from corrosion.

Further, even if some foaming agents are decomposed to generate acid during kneading and molding of the foam filling composition, the basic oxide can neutralize the acid. Therefore, even if an unwanted portion or a defective of the foam filling composition once molded is used again, radical decomposition of organic peroxide can be less reduced, which can obtain sufficient foaming ratio.

The amount of the basic oxide is not particularly limited, and is in the range of, for example, 0.05 to 70 parts by weight, or preferably 0.1 to 50 parts by weight, per 100 parts by weight of the foaming agent. When the amount of the basic oxide to the foaming agent is less than this range, the effect of neutralizing the acid generated by the decomposition of the foaming agent may be small. Conversely, when the amount of the basic oxide to the foaming agent is more than this range, the decomposition temperature of the foaming agent is excessively reduced, which can shift the timing of foaming and crosslinking, so that the foaming ratio may be decreased.

An epoxy resin, a filler, a crosslinking accelerator, a tackifier, a softening agent, or a processing auxiliary agent can be appropriately contained in the foam filling composition. Further, known additives, such as a thixotropic agent, pigment, an antiscorching agent, a stabilizer, a plasticizer, an antiaging agent, an ultraviolet absorber, an antioxidant, pigment, a coloring agent, a mildewproofing agent, and a fire retardant can be appropriately contained in the foam filling composition.

The epoxy resin is not particularly limited, and examples thereof include aromatic epoxy resin, aliphatic and alicyclic epoxy resin, and ring containing nitrogen epoxy resin.

The aromatic epoxy resin is an epoxy resin containing a benzene ring as a constitutional unit in a molecular chain. The aromatic epoxy resin is not particularly limited and examples thereof include bisphenol epoxy resin such as bisphenol A type epoxy resin, dimer acid modified bisphenol A type epoxy resin, bisphenol F type epoxy resin and bisphenol S type epoxy resin; novolak epoxy resin such as phenol novolak epoxy resin and cresol novolak epoxy resin; naphthalene epoxy resin; and biphenyl epoxy resin.

Examples of the aliphatic and alicyclic epoxy resin include hydrogenated bisphenol A type epoxy resin, dicyclo type epoxy resin and alicyclic epoxy resin.

Examples of the nitrogen containing ring epoxy resin include triglycidyl isocyanurate epoxy resin and hydantoin epoxy resin.

These epoxy resins may be used alone or in combination.

The blending of the epoxy resin can improve reinforcement of the foamed material 9.

Of these epoxy resins, aromatic epoxy resin, and aliphatic and alicyclic epoxy resin are preferably used, and bisphenol epoxy resin and alicyclic epoxy resin are more preferably used, in terms of reinforcement.

The epoxy equivalent of the epoxy resin is in the range of, for example, 150 to 1000 g/eq.

When the epoxy resin is blended, a curing agent may further be blended.

The curing agents that may be used include, for example, amine compounds, acid anhydride compounds, amide compounds, hydrazide compounds, imidazole compounds and imidazoline compounds. In addition to these, phenol compounds, urea compounds and polysulfide compounds can be used as the curing agent.

Examples of the amine compound include ethylenediamine, propylenediamine, diethylenetriamine, triethylenetetramine, amine adducts thereof, metaphenylenediamine, diaminodiphenylmethane, and diaminodiphenylsulfone.

Examples of the acid anhydride compound include phthalic anhydride, maleic anhydride, tetrahydrophthalic anhydride, hexahydrophthalic anhydride, methyl nadic anhydride, pyromellitic anhydride, dodecenylsuccinic anhydride, dichlorosuccinic anhydride, benzophenonetetracarboxylic anhydride, and chlorendic anhydride.

Examples of the amide compound include dicyandiamide and polyamide.

Examples of the hydrazide compound include dihydrazide such as adipic dihydrazide.

Examples of the imidazole compound include methyl imidazole, 2-ethyl-4-methyl imidazole, ethyl imidazole, isopropyl imidazole, 2,4-dimethylimidazole, phenylimidazole, undecylimidazole, heptadecylimidazole, and 2-phenyl-4-methylimidazole.

Examples of the imidazoline compound include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methyl imidazoline.

These curing agents may be used alone or in combination. Of these curing agents, dicyandiamide is preferably used.

The amount of the curing agent is in the range of, for example, 0.5 to 50 parts by weight, preferably 1 to 40 parts by weight, or more preferably 1 to 15 parts by weight, per 100 parts by weight of the epoxy resin, depending upon the equivalent ratio of the curing agent to the epoxy resin.

If desired, a curing accelerator can be used in combination with the curing agent. The curing accelerator that may be used include, for example, imidazoles, ureas, tertiary amines, phosphorus compounds, quaternary ammonium salts, and organic metal salts. These may be used alone or in combination. The amount of the curing accelerator is in the range of, for example, 0.1 to 20 parts by weight, or preferably 0.2 to 10 parts by weight, per 100 parts by weight of the epoxy resin.

The filler is not particularly limited, and examples thereof include calcium carbonate, aluminum hydroxide, magnesium carbonate, magnesium hydroxide, calcium oxide, silicic acid and the salts thereof, mica, clay, talc, mica powder, bentonite, silica, glass beads, glass balloon, Shirasu balloon, alumina, aluminum silicate, aluminum powder, carbon black, and acetylene black.

These fillers can be used alone or in combination of two or more kinds.

Of these fillers, calcium carbonate or carbon black is preferable.

The amount of the filler is in the range of, for example, 20 to 200 parts by weight, or preferably 40 to 120 parts by weight, per 100 parts by weight of the polymer, and the amount thereof is in the range of, for example, 10 to 90 parts by weight, or preferably 15 to 45 parts by weight, per 100 parts by weight of the foam filling composition.

Examples of the crosslinking accelerator include sulfides (e.g., monothiurams such as tetramethylthiuram monosulfide; and disulfides such as tetramethylthiuram disulfide, tetrabuthylthiuram disulfide, and di-2-benzothiazolyl disulfide), dithiocarbamic acids, thiazoles, guanidines, sulfenamides, thiurams, xanthogenic acids, aldehyde ammonias, aldehyde amines and thioureas.

These crosslinking accelerators can be used alone or in combination of two or more kinds.

Of these crosslinking accelerators, sulfide is preferable. Of sulfides, containing of tetrabuthylthiuram disulfide can optimize a crosslinking rate. This can prevent outgassing due to excessively slow crosslinking rate or prevent increase of closed cells produced due to excessively fast crosslinking rate.

The amount of the crosslinking accelerator is in the range of, for example, 1 to 20 parts by weight, or preferably 2 to 15 parts by weight, per 100 parts by weight of the polymer, and the amount thereof is in the range of, for example, 0.5 to 10 parts by weight, or preferably 1 to 5 parts by weight, per 100 parts by weight of the foam filling composition.

The tackifier is not particularly limited, and examples thereof include rosin resin, terpene resin (e.g., terpene-aromatic liquid resin, etc.), cumarone-indene resin, and petroleum resin (e.g., C5 petroleum resin, C5/C9 petroleum resin, etc.).

These tackifiers can be used alone or in combination of two or more kinds.

Of these tackifiers, petroleum resin is preferable.

The amount of the tackifier is in the range of, for example, 1 to 20 parts by weight, or preferably 2 to 15 parts by weight, per 100 parts by weight of the polymer, and the amount thereof is in the range of, for example, 1 to 10 parts by weight, or preferably 2 to 6 parts by weight, per 100 parts by weight of the foam filling composition.

The softening agent is not particularly limited, and examples thereof include phthalic acid oil, paraffin oil, naphthene oil, fatty acid oil, and phosphoric acid oil.

These softening agents can be used alone or in combination of two or more kinds.

Of these softening agents, phthalic acid oil and paraffin oil are preferable.

The amount of the softening agent is in the range of, for example, 10 to 150 parts by weight, or preferably 30 to 120 parts by weight, per 100 parts by weight of the polymer, and the amount thereof is in the range of, for example, 10 to 50 parts by weight, or preferably 15 to 25 parts by weight, per 100 parts by weight of the foam filling composition.

Examples of the processing auxiliary agent include lubricant such as stearic acid and esters thereof.

These processing auxiliary agents can be used alone or in combination of two or more kinds.

The amount of the processing auxiliary agent can be appropriately selected according to the purposes and applications.

The foam filling composition can be prepared as a kneaded material by blending the above-mentioned components in the above-mentioned amounts, and kneading them, for example, with a mixing roll, a pressure kneader, or an extruder, under the temperature conditions where less decomposition of the foaming agent occurs, though not limited thereto.

Then, the foam filling material 11 for wind power generator blades can be obtained by forming the foam filling composition thus prepared into a given shape so as to be positioned in the interior space of the wind power generator blade 4. Such foam filling material 11 for wind power generator blades can fill the interior space of the wind power generator blade 4 by foaming.

The method for forming the foam filling composition into a given shape is not particularly limited, and the foam filling composition can be formed into a given shape, for example, by pelletizing the kneaded material using a pelletizer and molding the resulting pellets into a given shape under the temperature conditions where less decomposition of the foaming agent occurs using an injection molding machine or an extruder, or directly molding it into a specified shape by a calendar or press forming.

The shape of the foam filling material 11 for wind power generator blades may be appropriately selected according to the shape of the hollow space or the filling portion in the wind power generator blade 4. When formed, for example, in a sheet shape, the foam filling material 11 for wind power generator blades is produced with good production efficiency at low cost by continuously forming the sheet thereof.

The thickness of the foam filling material 11 for wind power generator blades is appropriately adjusted with the shape of the hollow space or the filling portion of the wind power generator blade 4, and is generally set to 0.5 to 10.0 mm, or preferably 1.0 to 5.0 mm. A thickness less than 0.5 mm may not enable the hollow space of the wind power generator blade 4 to sufficiently be filled. A thickness beyond 10.0 mm may cause difficulty in attaching (inserting) the foam filling material 11 when the hollow space of the wind power generator blade 4 is narrow.

In the method for producing the wind power generator blade 4, the obtained foam filling material 11 for wind power generator blades is positioned in the interior space of the wind power generator blade 4.

Known methods may be used for the positioning and, for example, first, as described above, the clip 12 is attached to the foam filling material 11 for wind power generator blades, so that the foam filling member 10 for wind power generator blades is formed.

Subsequently, as shown in FIG. 2(a), the clip 12 is inserted through the girder 6 so as to penetrate the girder 6 in the thickness direction, so that the clip 12 is attached in the interior space of the wind power generator blade 4. Then, the foam filling member 10 for wind power generator blades is positioned by fixing it to the interior space of the wind power generator blade 4.

Thereafter, in this method, the foam filling material 11 for wind power generator blades is foamed to fill the interior space of the wind power generator blade 4.

More specifically, the wind power generator blade 4 (before foaming) of which the foam filling member 10 for wind power generator blades is positioned in the interior space is heated under appropriate conditions (e.g., 120 to 220° C., or preferably 140 to 180° C.), so that the foam filling material 11 for wind power generator blades is foamed, crosslinked, and cured. This forms the foamed material 9 to fill the interior space of the wind power generator blade 4.

Thus, as shown in FIG. 3, the wind power generator blade 4 (after foaming) of which the interior space is filled with the foamed material 9 can be obtained.

In this method, the foam filling material 11 for wind power generator blades is positioned in the interior space of the wind power generator blade 4 and then foamed to fill the interior space thereof. Therefore, the interior space of the wind power generator blade 4 can be densely filled with the foam filling material 11 for wind power generator blades, without leaving any gap between the inner side surface of the wind power generator blade 4 and the outer side surface of the foamed material 9. As a result, vibration can be effectively suppressed and furthermore, the rigidity of the wind power generator blade 4 can be secured.

According to the foam filling member 10 for wind power generator blades, the foam filling material 11 for wind power generator blades can be attached in the interior space of the wind power generator blade 4 using the clip 12. This allows the foam filling material 11 for wind power generator blades to be arranged in the interior space of the wind power generator blade 4 by reliably positioning the foam filling material 11 corresponding to the size and shape of the wind power generator blade 4. As a result, vibration can be more effectively suppressed and furthermore, the rigidity of the wind power generator blade 4 can be secured.

Further, the wind power generator blade 4 can prevent a gap from occurring between the inner side surface of the wind power generator blade 4 and the outer side surface of the foamed material 9, so that vibration can be effectively suppressed, and furthermore, the rigidity can be secured.

With the wind power generator 1 provided with such wind power generator blades 4, vibration of the wind power generator blade 4 can be effectively suppressed, and furthermore, the rigidity can be secured, so that vibration noise can be reduced, and durability and power generation efficiency can be improved.

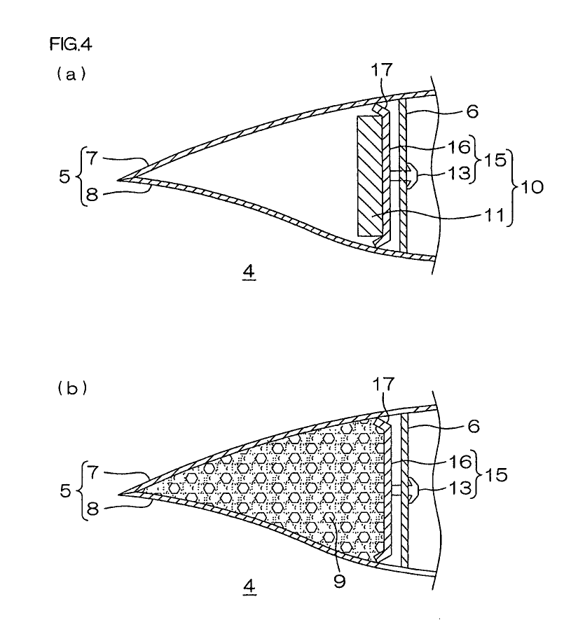

FIG. 4(a) is a schematic sectional view of a major portion of a wind power generator blade (before foaming) which adopts another embodiment (a mode where the foaming direction of a foaming filler for wind power generator blades is regulated by a supporting portion) of the foam filling member for wind power generator blades according to the present invention; and FIG. 4(b) is a schematic sectional view of a major portion of a wind power generator blade (after foaming) which adopts the foam filling member for wind power generator blades shown in FIG. 4(a).

The same reference numerals are provided in each of the following figures for members corresponding to each of those described above, and their detailed description is omitted.

In FIG. 4(a), the foam filling member 10 for wind power generator blades includes a holder member 15 as an attachment member, and a foam filling material 11 for wind power generator blades.

The material that may be used to form the holder member 15 is not particularly limited as long as it is not deformed and supports the foam filling material 11 for wind power generator blades during the above-mentioned foaming by heating. Examples thereof include hard resin such as nylon and polyester, and metal such as iron, stainless steel, and aluminium.

The holder member 15 integrally include a supporting plate 16 serving as the supporting portion that supports the foam filling material 11 for wind power generator blades and a fixing hook 13.

The supporting plate 16 is formed in a flat plate shape, and includes a weir wall 17 on the peripheral end of one side surface thereof. The weir wall 17 is formed by inclining at a predetermined angle which intersects a direction where the support plate 16 extends.

The fixing hook 13 is formed by protruding so as to extend from the rear surface (the other side surface opposite to one side surface where the foam filling material 11 for wind power generator blades is positioned) of the supporting plate 16 in a direction generally perpendicular to the direction where the supporting plate 16 extends.

For example, when formed of the above-mentioned resin, such holder member 15 can be obtained by integrally molding the supporting plate 16, the weir wall 17, and the fixing hook 13 by injection molding.

The foam filling material 11 for wind power generator blades is the same foam filling material 11 for wind power generator blades as above, and is formed in a rather smaller sheet shape than the supporting plate 16.

In the foam filling member 10 for wind power generator blades, the supporting plate 16 supports the foam filling material 11 for wind power generator blades so that the foaming direction of the foam filling material 11 for wind power generator blades is regulated (i.e., the foaming direction of the foam filling material 11 for wind power generator blades orients toward a direction where filling is required in the interior space).

The method for supporting the foam filling material 11 for wind power generator blades is not particularly limited, and examples thereof include a method of adhesively bonding the foam filling material 11 for wind power generator blades to one side surface of the supporting plate 16, and a method of forming a locking piece (not shown) protruding on one side surface of the supporting plate 16, and then locking the foam filling material 11 for wind power generator blades by the locking piece.

The foam filling member 10 for wind power generator blades is positioned and fixed in the interior space of the wind power generator blade 4 by the fixing hook 13, and is then heated under an appropriate conditions in the same manner as above. Thus, the foam filling material 11 for wind power generator blades is foamed, crosslinked, and cured to form the foamed material 9, which fills the interior space of the wind power generator blade 4.

Therefore, for example, as shown in FIG. 4(b), the wind power generator blade 4 (after foaming) in which only the interior space of one end portion in the rotation direction of the wind power generator blade 4 is filled with the foamed material 9 can be obtained.

As seen above, when the foam filling material 11 for wind power generator blades is supported by the supporting plate 16, the foam filling material 11 for wind power generator blades can be arranged in a more suitable position in the interior space of the wind power generator blade 4.

When the supporting plate 16 is used to regulate the foaming direction of the foam filling material 11 for wind power generator blades, a space required to be filled in the interior space of the wind power generator blade 4 can be more reliably filled.

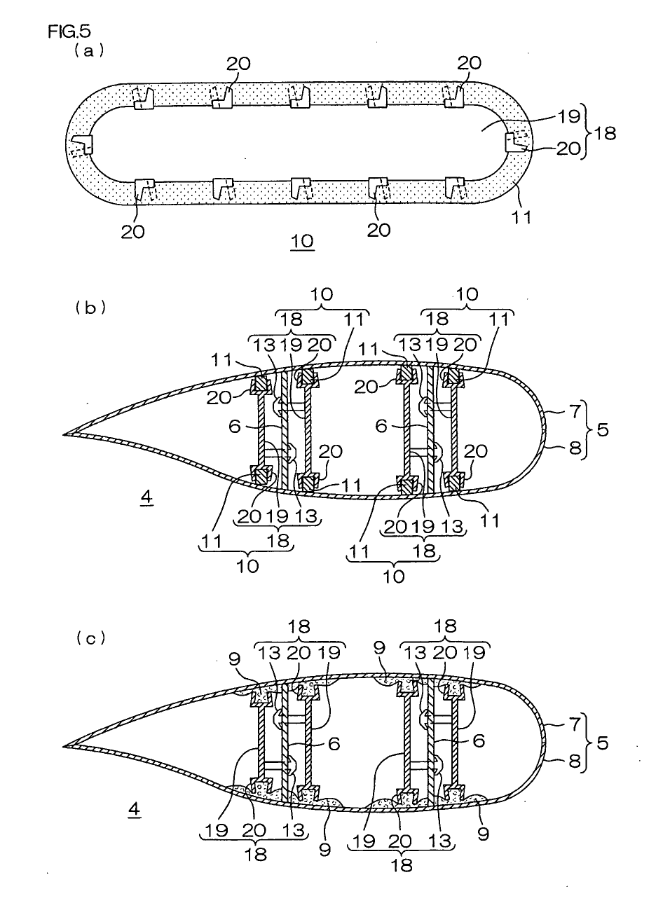

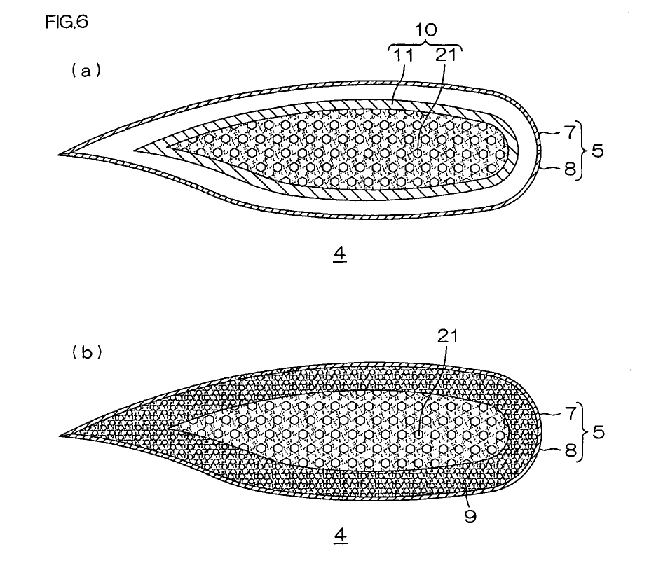

FIG. 5(a) is a schematic plan view of another embodiment (a mode where a foam filling material for wind power generator blades is arranged between the inner side surface of the wind power generator blade and a supporting portion) of the foam filling member for wind power generator blades according to the present invention; FIG. 5(b) is a sectional view of a wind power generator blade (before foaming) which adopts the foam filling member for wind power generator blades shown in FIG. 5(a); and FIG. 5(c) is a sectional view of a wind power generator blade (after foaming) which adopts the foam filling member for wind power generator blades shown in FIG. 5(b).

In FIG. 5(a), the foam filling member 10 for wind power generator blades includes a holder member 18 as an attachment member, and a foam filling material 11 for wind power generator blades.

The material that forms the holder member 18 includes the same material as that forms the above-mentioned holder member 15.

The holder member 18 integrally include a supporting plate 19 and a gripping piece 20 serving as the supporting portion that supports the foam filling material 11 for wind power generator blades, and a fixing hook 13 (see FIG. 5(b)).

The supporting plate 19 is formed in the shape slightly smaller than and analogous to the sectional shape of the interior space of the wind power generator blade 4 to be filled, for example, in an elliptical shape in plan view.

The gripping piece 20 is provided in one pair on both sides of the supporting plate 19 in the thickness direction so as to grip the foam filling material 11 for wind power generator blades supported on the outer peripheral surface of the supporting plate 19 from both sides thereof in the thickness direction. The gripping piece 20 includes a plurality of gripping pieces circumferentially arranged at given spaced intervals in the peripheral end of the supporting plate 19.

As shown in FIG. 5(b), the fixing hook 13 is formed protruding from one side surface of the supporting plate 19 so as to extend along the direction generally perpendicular to the direction where the support plate 19 extends.

For example, when formed of the above-mentioned resin, such holder member 18 can be obtained by integrally molding the supporting plate 19, the gripping piece 20, and the fixing hook 13 by injection molding.

The foam filling material 11 for wind power generator blades is the same foam filling material 11 for wind power generator blades as the above, having an elongated sheet shape and formed in almost the same length as the circumferential length of the peripheral surface of the supporting plate 19, as shown in FIG. 5(a).

In the holder member 18, such foam filling material 11 for wind power generator blades is positioned along the peripheral surface of the supporting plate 19, and is gripped (locked) by the gripping piece 20.

Then, as shown in FIG. 5(b), the foam filling member 10 for wind power generator blades is positioned and fixed in the interior space of the wind power generator blade 4 by the fixing hook 13 in the same manner as above.

Thus, in the foam filling member 10 for wind power generator blades, the supporting plate 19 is positioned generally parallel to the girder 6, whereby the supporting plate 19 and the gripping piece 20 support the foam filling material 11 for wind power generator blades so that the foam filling material 11 for wind power generator blades is positioned between the inner side surface of the wind power generator blade 4, and the supporting plate 19 and the gripping piece 20.

The foam filling member 10 for wind power generator blades is then heated under an appropriate conditions in the same manner as above. Thus, the foam filling material 11 for wind power generator blades is foamed, crosslinked, and cured to form the foamed material 9, which fills the interior space of the wind power generator blade 4.

Therefore, as shown in FIG. 5(c), the interior space of the wind power generator blade 4, more specifically, the wind power generator blade 4 (after foaming) filled with the foamed material 9 between the inner side surface of the wind power generator blade 4, and the supporting plate 19 and the gripping piece 20 can be obtained.

As seen above, when the foam filling material 11 for wind power generator blades is positioned between the inner side surface of the wind power generator blade 4 and the supporting portion, the foamed material 9 obtained by foaming is reliably filled between the inner side surface of the wind power generator blade 4, and the outer side surface of the foamed material 9. Therefore, a gap can be reliably prevented from occurring between the inner side surface of the wind power generator blade 4, and the outer side surface of the foamed material 9.

In addition, the placement of the holder member 18 allows the wind power generator blade 4 to be reinforced in parallel with the girder 6.

FIG. 6(a) is a sectional view of a wind power generator blade (before foaming) which adopts another embodiment (a mode where a reinforcing member made of foamed material is covered with a foam filling material for wind power generator blades) of the foam filling member for wind power generator blades of the present invention, and FIG. 6(b) is a sectional view of a wind power generator blade (after foaming) which adopts the foam filling member for wind power generator blades shown in FIG. 6(a).

In FIG. 6(a), the wind power generator blade 4 is formed not including the girder 6, without dividing the interior space thereof into plural pieces.

In the wind power generator blade 4, the foam filling member 10 for wind power generator blades includes a foam filling material 11 for wind power generator blades, and a reinforced foamed material 21 as a reinforcing member which is covered with the foam filling material 11 for wind power generator blades to reinforce the interior space of the wind power generator blade 4.

The material that may be used to form the reinforced foamed material 21 is not particularly limited as long as it can reinforce the wind power generator blade 4 and supports the foam filling material 11 for wind power generator blades during the above-mentioned foaming by heating. Examples thereof include foamed materials having high rigidity, more specifically, polyurethane foamed material, acrylic foamed material, polystyrene foamed material, polyimide foamed material, vinyl chloride foamed material, and phenol foamed material.

Such reinforced foamed material 21 has, for example, a generally drop-shaped cross-section which is smaller than and generally analogous to the cross-section of the wind power generator blade 4, and it can be formed in the shape substantially the same radial length as the radial length of the wind power generator blade 4 (the radial direction of a circular path generated when the wind power generator blade 4 circulates around the rotating shaft 3 (see FIG. 1), the same applies to the following).

The foam filling material 11 for wind power generator blades is the same foam filling material 11 for wind power generator blades as the above, formed, for example, in a sheet shape having substantially the same surface area as that of the reinforced foamed material 21.

In the foam filling member 10 for wind power generator blades, the surface of the reinforced foamed material 21 is covered with the foam filling material 11 for wind power generator blades.

The method for covering the reinforced foamed material 21 is not particularly limited and for example, the foam filling material 11 for wind power generator blades is adhesively bonded to the surface of the reinforced foamed material 21.

Then, the foam filling member 10 for wind power generator blades is positioned radially along the wind power generator blade 4 in the interior space of the wind power generator blade 4.

The wind power generator blade 4 is usually formed with its radial central portion swelling from both end portions thereof, and the foam filling member 10 for wind power generator blades is abutted against and fixed to both radial ends of the wind power generator blade 4, thereby being positioned without touching the inner side surface of the radial central portion thereof.

In the same manner as above, the wind power generator blade 4 (before foaming) is heated under appropriate conditions to foam, crosslink, and cure the foam filling material 11 for wind power generator blades, thereby forming the foamed material 9 to fill up in the interior space of the wind power generator blade 4.

Therefore, as shown in FIG. 6(b), the wind power generator blade 4 (after foaming) of which the interior space is filled with the foamed material 9 can be obtained.

According to the foam filling member 10 for wind power generator blades, the reinforced foamed material 21 can reinforce the wind power generator blade 4. As a result, while the reinforced foamed material 21 can further increase the rigidity of the wind power generator blade 4, the foam filling material 11 for wind power generator blades can effectively suppress vibration.

In addition, since the foam filling material 11 for wind power generator blades covers the reinforced foamed material 21, after foaming of the foam filling material 11 for wind power generator blades, the inner side surface of the wind power generator blade 4 and the outer side surface of the reinforced foamed material 21 are densely stuck by the foamed material 9 of the foam filling material 11 for wind power generator blades. This can achieve further improved reinforcement and vibration damping property.

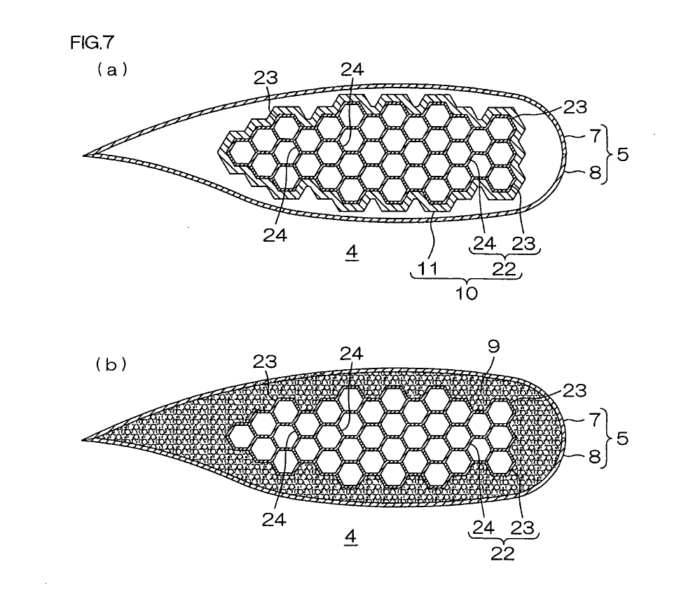

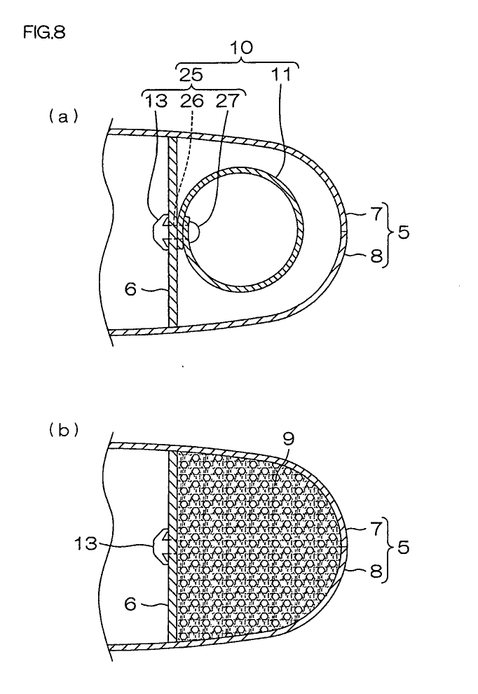

FIG. 7(a) is a sectional view of a wind power generator blade (before foaming) which adopts another embodiment (a mode where a reinforcing member made of a honeycomb structured body is covered with a foam filling material for wind power generator blades) of the foam filling member for wind power generator blades of the present invention, and FIG. 7(b) is a sectional view of a wind power generator blade (after foaming) which adopts the foam filling member for wind power generator blades shown in FIG. 7(a).

In FIG. 7 (a), the wind power generator blade 4 is formed without including a girder 6.

In the wind power generator blade 4, the foam filling member 10 for wind power generator blades includes a foam filling material 11 for wind power generator blades, and a reinforcement structure 22 serving as a reinforcing member which is covered with the foam filling material 11 for wind power generator blades to reinforce the interior space of the wind power generator blade 4.

The material that may be used to form the reinforcement structure 22 is not particularly limited as long as it can reinforce the wind power generator blade 4 and supports the foam filling material 11 for wind power generator blades during the above-mentioned foaming by heating. Examples thereof include the same materials as those used to form the above-mentioned holder member 15.

Such reinforcement structure 22 includes an outer wall 23, a plurality of partition walls 24 for dividing the interior space of the wind power generator blade 4 into a plurality of spaces.

The outer wall 23 forms the outline of the reinforcement structure 22 and is formed in a cylindrical shape enclosing (a part of) the interior space of the wind power generator blade 4.

The partition wall 24 is continuously formed from the inner surface of the outer wall 23 so as to divide the interior space of the wind power generator blade 4 enclosed with the reinforcement structure 22 into a plurality of spaces (divided chambers) each having a regular hexagon as viewed in cross section.

Thus, the reinforcement structure 22 is formed as a hollow honeycomb structure of which a plurality of divided chambers are aligned inside.

In the same manner as the reinforced foamed material 21, such reinforcement structure 22 is formed in the shape substantially the same radial length as the radial length of the wind power generator blade 4.

The foam filling material 11 for wind power generator blades is the same foam filling material 11 for wind power generator blades as the above, for example, formed in a sheet shape having substantially the same surface area as that of the outer side surface of the reinforcement structure 22 (the surface opposite to the side where the divided walls 24 on the outer wall 23 are formed).

In the foam filling member 10 for wind power generator blades, the outer side surface of the reinforcement structure 22 is then covered with the foam filling material 11 for wind power generator blades.

The method for covering the reinforcement structure 22 is not particularly limited and for example, the foam filling material 11 for wind power generator blades is adhesively bonded to the outer side surface of the reinforcement structure 22 in the same manner as above.

The foam filling member 10 for wind power generator blades is positioned radially along the wind power generator blade 4 in the interior space of the wind power generator blade 4.

In the same manner as above, the wind power generator blade 4 (before foaming) is heated under appropriate conditions to foam, crosslink, and cure the foam filling material 11 for wind power generator blades, thereby forming the foamed material 9 to fill up in the interior space of the wind power generator blade 4.

Therefore, as shown in FIG. 7(b), the wind power generator blade 4 (after foaming) of which the interior space is filled with the foamed material 9 can be obtained.

According to this structure, since the reinforcement structure 22 includes the plurality of partition walls 24, the wind power generator blade 4 can be reduced in weight, and the rigidity thereof can be improved.

In the above explanation, the divided chamber formed in the inner portion of the reinforcement structure 22 is a cylindrical structure having a regular hexagon as viewed in cross section. The structure of the divided chamber is however not particularly limited, and appropriate structures such as a cylindrical structure having a regular triangle as viewed in cross section or a cylindrical structure having a regular tetragon as viewed in cross section can be adopted, though not shown.

In the above explanation, the foam filling material 11 for wind power generator blades is positioned only on the outer side surface of the reinforcement structure 22. The foam filling material 11 for wind power generator blades can however be positioned in all or any divided chamber and foamed, so that the inside of the divided chambers can be filled with the foamed material 9.

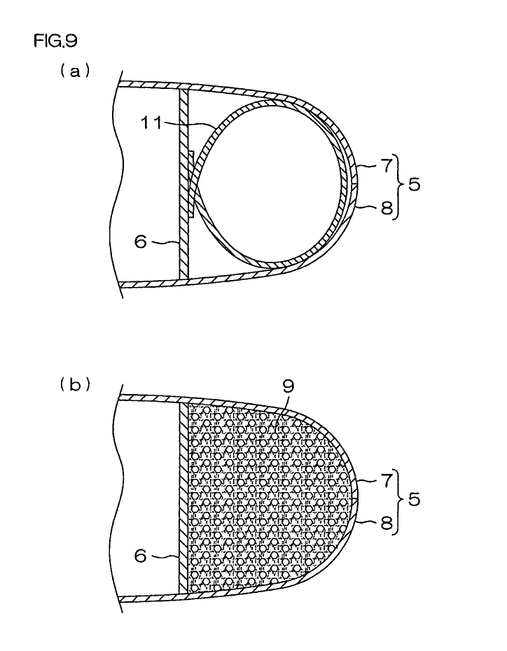

FIG. 8(a) is a schematic sectional view of a major portion of a wind power generator blade (before foaming) which adopts another embodiment (a mode where a loop shape of a foam filling material for wind power generator blades is held by an attachment member) of the foam filling member for wind power generator blades of the present invention, and FIG. 8(b) is a schematic sectional view of a major portion of a wind power generator blade (after foaming) which adopts the foam filling member for wind power generator blades shown in FIG. 8(a).

In FIG. 8(a), the foam filling member 10 for wind power generator blades includes an insertion clip 25 as an attachment member and a foam filling material 11 for wind power generator blades.

The material that may be used to form the insertion clip 25 is not particularly limited, and examples thereof include the same material as used to form the above-mentioned clip 12.

Such insertion clip 25 integrally includes a fixed hook 13, an insertion portion 26 to be inserted through the foam filling material 11 for wind power generator blades, and a locking projection 27 which locks the foam filling material 11 for wind power generator blades.

The foam filling material 11 for wind power generator blades is the same foam filling material 11 for wind power generator blades as the above, for example, formed in the shape of a strip-like sheet and also formed in a loop shape (an endless shape) in which both lengthwise ends of the foam filling material 11 for wind power generator blades are overlapped in the thickness direction by bending.

Then, in the foam filling member 10 for wind power generator blades, the insertion portion 26 of the insertion clip 25 is inserted into a portion where the foam filling material 11 for wind power generator blades overlaps in the thickness direction to be opposed (hereinafter referred to as an overlapping portion) so as to penetrate the overlapping portion in the thickness direction from the outside of the loop shape toward the inside thereof, whereby the locking projection 27 protrudes on the inside thereof.

In the same manner as above, the foam filling member 10 for wind power generator blades is positioned in the interior space of the wind power generator blade 4 by the fixing hook 13 and is then heated under appropriate conditions. Thus, the foam filling material 11 for wind power generator blades is foamed, crosslinked, and cured to form the foamed material 9, which fills the interior space of the wind power generator blade 4.

Therefore, as shown in FIG. 8(b), the wind power generator blade 4 (after foaming) of which the interior space is filled with the foamed material 9 can be obtained.

In the foam filling member 10 for wind power generator blades, the loop shape of the foam filling material 11 for wind power generator blades can be held with the insertion clip 25 for attaching the foam filling material 11 for wind power generator blades to the interior space of the wind power generator blade 4. Therefore, it is unnecessary to use any additional member for holding the loop shape of the foam filling material 11 for wind power generator blades, and without increasing the number of parts, the foam filling material 11 for wind power generator blades can stably maintain its loop shape.

When the foam filling material 11 for wind power generator blades stably holds its loop shape, the interior space of the wind power generator blade 4 corresponding to the loop shape can be effectively filled with the foamed material 9. This allows the vibration of the wind power generator blade 4 to be effectively suppressed, and furthermore, the rigidity can be secured.

In other words, with the foam filling member 10 for wind power generator blades, the foam filling material 11 for wind power generator blades can be formed into a loop shape having any size depending upon the interior space of the wind power generator blade 4 and fill the interior space. Therefore, the time and effort required to form the foam filling material 11 for wind power generator blades depending upon the interior space of the wind power generator blade 4 can be omitted.

FIG. 9(a) is a schematic sectional view of a major portion of a wind power generator blade (before foaming) which adopts another embodiment (a mode where a foam filling material for wind power generator blades having a loop shape is fixed by engaging slits in the overlapping portion) of the foam filling member for wind power generator blades of the present invention, and FIG. 9(b) is a schematic sectional view of a major portion of a wind power generator blade (after foaming) which adopts the foam filling member for wind power generator blades shown in FIG. 9(a).

In the above explanation, the insertion portion 26 of the insertion clip 25 is inserted through the overlapping portion of the foam filling material 11 for wind power generator blades to lock it at the locking projection 27, so that the foam filling material 11 for wind power generator blades holds its loop shape and is fixedly positioned in the interior space of the wind power generator blade 4 by the fixing hook 13. However, for example, without using the insertion clip 25, the foam filling material 11 for wind power generator blades can be fixedly positioned in the interior space of the wind power generator blade 4 while maintaining its loop shape.

In FIG. 9(a), the foam filling material 11 for wind power generator blades is formed in the shape of a strip-like sheet in the same manner as above.

In the foam filling material 11 for wind power generator blades, slits (not shown) made midway along the widthwise direction (a direction perpendicular to the lengthwise direction) thereof are formed in a portion where the overlapping portion is formed, each being made from the opposite sides to each other in the widthwise direction.

The foam filling material 11 for wind power generator blades is then bent in the same manner as above, thereby forming into a loop shape (an endless shape) so that both lengthwise ends of the foam filling material 11 for wind power generator blades overlap to form an overlapping portion (intersecting portion). Then, the slits formed in the overlapping portion are fitted together for engagement with each other.

Thus, the slits are engaged in the overlapping portion to be fixed to each other, so that the shape of the foam filling material 11 for wind power generator blades is maintained in the loop shape.

The foam filling material 11 for wind power generator blades thus formed is fixedly positioned in the interior space of the wind power generator blade 4 by coming into pressure contact with the inner side surface of the wind power generator blade 4 with an elastic force of the foam filling material 11 for wind power generator blades.

In the same manner as above, the wind power generator blade 4 (before foaming) is heated under appropriate conditions to foam, crosslink, and cure the foam filling material 11 for wind power generator blades, thereby forming the foamed material 9 to fill up in the interior space of the wind power generator blade 4.

Therefore, as shown in FIG. 9(b), the wind power generator blade 4 (after foaming) of which the interior space is filled with the foamed material 9 can be obtained.

In the foam filling material 11 for wind power generator blades, the slits provided in the foam filling material 11 for wind power generator blades itself allow the foam filling material 11 for wind power generator blades to hold a loop shape corresponding to the size of the interior space of the wind power generator blade 4, so that the foam filling material 11 for wind power generator blades can be stably positioned in a size suitable for the interior space of the wind power generator blade 4. This enables the foam filling material 11 for wind power generator blades to be stably foamed in a suitable size without distorting its loop shape due to displacement of the foam filling material 11 for wind power generator blades. Therefore, the foamed material 9 can reliably and stably fill the interior space without leaving any gap.

This method also eliminates the need to attach the foam filling material 11 for wind power generator blades as described later, so that it can be positioned on the inner side surface of the wind power generator blade 4 with good sufficient working efficiency.

In the above explanation, the foam filling material 11 for wind power generator blades has a loop shape. However, for example, the foam filling material 11 for wind power generator blades can be formed by bending into a given shape corresponding to the interior space of the wind power generator blade 4, and can also be fixedly positioned on the inner side surface of the wind power generator blade 4.

In such case, though not shown, the foam filling material 11 for wind power generator blades is formed into a sheet shape, and slits made midway along the bent portion in the thickness direction and/or cuts penetrating the thickness direction are also formed in the foam filling material 11 for wind power generator blades. Then, the slits and/or cuts are inclined to form the foam filling material 11 for wind power generator blades into any shape.

The foam filling material 11 for wind power generator blades is fixedly positioned in the interior space of the wind power generator blade 4 corresponding to the shape, and is then heated under appropriate conditions to foam, crosslink, and cure the foam filling material 11 for wind power generator blades, thereby forming the foamed material 9 to fill up in the interior space of the wind power generator blade 4.

According to this method, a simple construction allows the foam filling material 11 for wind power generator blades to be formed into a given shape corresponding to the interior space of the wind power generator blade 4 with good working efficiency, so that the foam filling material 11 for wind power generator blades can be positioned in the interior space of the wind power generator blade 4.

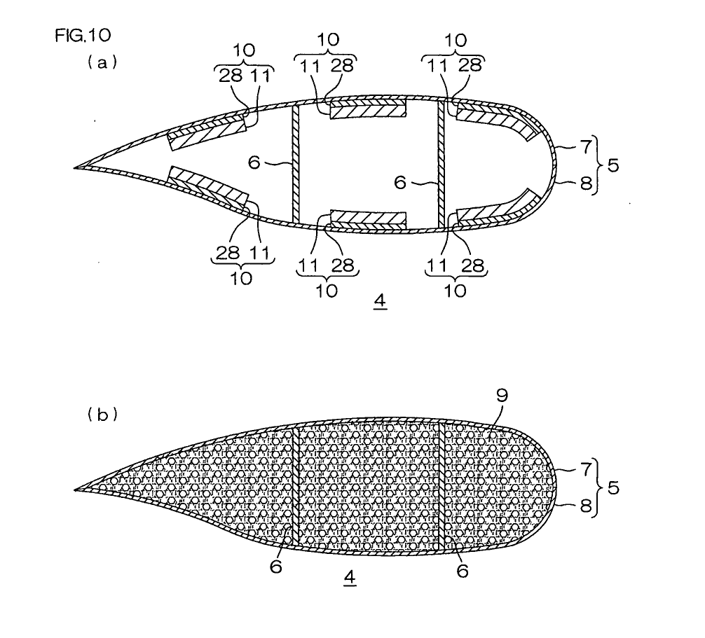

FIG. 10(a) is a sectional view of a wind power generator blade (before foaming) which adopts another embodiment (a mode where a foam filling material for wind power generator blades is fixed with an adhesive layer) of the foam filling member for wind power generator blades of the present invention, and FIG. 10(b) is a sectional view of a wind power generator blade (after foaming) which adopts the foam filling member for wind power generator blades shown in FIG. 10(a).

In FIG. 10(a), the foam filling member 10 for wind power generator blades includes an adhesive layer 28 as an attachment member, and the foam filling material 11 for wind power generator blades.

The adhesive layer 28 is not particularly limited, and can be formed, for example, in the following manner. A known adhesive such as acrylic adhesive or rubber adhesive is rolled into a sheet shape by calendaring, extrusion, or press molding to form the adhesive layer 28.

The foam filling material 11 for wind power generator blades is the same foam filling material 11 for the wind power generator blade as the above, for example, formed in a sheet shape which is generally the same shape in plan view as the adhesive layer 28.

The adhesive layer 28 and the foam filling material 11 for wind power generator blades are laminated by sticking them together, so that the foam filling member 10 for wind power generator blades is formed.

The method for sticking the adhesive layer 28 and the foam filling material 11 for wind power generator blades together is not particularly limited. For example, a kneaded material made of foam filling composition is continuously extruded with an extruder to continuously form the foam filling material 11 for wind power generator blades, and an adhesive is also continuously extruded with an extruder to continuously form the adhesive layer 28. Thereafter, the foam filling material 11 for wind power generator blades and the adhesive layer 28 are overlapped to continuously press-contact to each other with a calendar roll. The foam filling member 10 for wind power generator blades thus obtained is cut into an appropriate length.

As shown in FIG. 10(a), the foam filling member 10 for wind power generator blades is fixedly positioned in the interior space of the wind power generator blade 4, for example, by adhesively bonding the adhesive layer 28 to the inner side surface (surfaces of the first skin 7 and the second skin 8) of the wind power generator blade 4.

In the same manner as above, the wind power generator blade 4 (before foaming) is heated under appropriate conditions to foam, crosslink, and cure the foam filling material 11 for wind power generator blades, thereby forming the foamed material 9 to fill up in the interior space of the wind power generator blade 4.

Therefore, as shown in FIG. 10(b), the wind power generator blade 4 (after foaming) of which the interior space is filled with the foamed material 9 can be obtained.

Since such foam filling member 10 for wind power generator blades can be molded into a simple and free shape, it can be effectively fixed to any position in the interior space of the wind power generator blade 4.

Therefore, according to such foam filling member 10 for wind power generator blades, the interior space of the wind power generator blade 4 can be efficiently filled with the foamed material 9. As a result, vibration of the wind power generator blade 4 can be effectively suppressed, and furthermore, the rigidity can be secured.

In the above explanation, the adhesive layer 28 is adhesively bonded on surfaces of the first skin 7 and the second skin 8. Though not shown, the adhesive layer 28, however, can be adhesively bonded to the surfaces (both-side surfaces) of the girder 6.

In the above explanation, although the adhesive layer 28 is used as the attachment member, it is not particularly limited as the attachment member. Though not shown, for example, a sucker or a magnet can be used as the attachment member to achieve fixing by suction or magnetic force. Further, the attachment member is composed of a metal plate so that it can be attached to the inner side surface of the wind power generator blade 4 by welding.

According to the foam filling material 11 for wind power generator blades, the foam filling member 10 for wind power generator blades, the wind power generator blade 4, the wind power generator 1, and the method for producing the wind power generator blade 4, vibration can be effectively suppressed and furthermore, the rigidity of the wind power generator blade 4 can be secured.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A foam filling material for wind power generator blades, obtained by forming a foam filling composition comprising a polymer and a foaming agent into a given shape so as to be positioned in an interior space of a wind power generator blade, and being capable of filling the interior space of the wind power generator blade by foaming.

2. A foam filling member for wind power generator blades, comprising:
a foam filling material for wind power generator blades, obtained by forming a foam filling composition comprising a polymer and a foaming agent into a given shape so as to be positioned in an interior space of a wind power generator blade, and being capable of filling the interior space of the wind power generator blade by foaming; and
an attachment member mounted to the foam filling material for wind power generator blades and attachable in the interior space of the wind power generator blade.

3. The foam filling member for wind power generator blades according to claim 2, wherein the attachment member comprises a supporting portion for supporting the foam filling material for wind power generator blades.

4. The foam filling member for wind power generator blades according to claim 3, wherein the supporting portion supports the foam filling material for wind power generator blades so as to regulate a foaming direction of the foam filling material for wind power generator blades.

5. The foam filling member for wind power generator blades according to claim 3, wherein the supporting portion supports the foam filling material for wind power generator blades so that the foam filling material for wind power generator blades is positioned between an inner side surface of the wind power generator blade and the supporting portion.

6. A foam filling member for wind power generator blades comprising:
a foam filling material for wind power generator blades, obtained by forming a foam filling composition comprising a polymer and a foaming agent into a given shape so as to be positioned in an interior space of a wind power generator blade, and being capable of filling the interior space of the wind power generator blade by foaming; and
a reinforcing member covered with the foam filling material for wind power generator blades to reinforce the interior space of the wind power generator blade.

7. The foam filling member for wind power generator blades according to claim 6, wherein the reinforcing member comprises a plurality of partition walls for dividing the interior space of the wind power generator blade into a plurality of spaces.

8. A wind power generator blade having its interior space filled with a foamed material obtained by positioning
a foam filling material for wind power generator blades, obtained by forming a foam filling composition comprising a polymer and a foaming agent into a given shape so as to be positioned in an interior space of a wind power generator blade, and being capable of filling the interior space of the wind power generator blade by foaming; or
a foam filling member for wind power generator blades comprising the foam filling material for wind power generator blades and a reinforcing member covered with the foam filling material for wind power generator blades to reinforce the interior space of the wind power generator blade,
in the interior space of the wind power generator blade and then foaming it.

9. A wind power generator comprising a wind power generator blade having its interior space filled with a foamed material obtained by positioning
a foam filling material for wind power generator blades, obtained by forming a foam filling composition comprising a polymer and a foaming agent into a given shape so as to be positioned in an interior space of a wind power generator blade, and being capable of filling the interior space of the wind power generator blade by foaming; or
a foam filling member for wind power generator blades comprising the foam filling material for wind power generator blades and a reinforcing member covered with the foam filling material for wind power generator blades to reinforce the interior space of the wind power generator blade
in the interior space of the wind power generator blade and then foaming it.

10. A method for producing a wind power generator blade comprising the steps of:
forming a foam filling composition comprising a polymer and a foaming agent into a given shape so as to be positioned in an interior space of a wind power generator blade to thereby obtain a foam filling material for wind power generator blades;
positioning the foam filling material for wind power generator blades in the interior space of the wind power generator blade; and
foaming the foam filling material for wind power generator blades to fill the interior space of the wind power generator blade.
